(19) United States
(12) Patent Application Publication
(10) Pub. No.: US 2017/0211915 A1
(43) Pub. Date: Jul. 27, 2017

(54) LASER COMPOSITE SYSTEM

(71) Applicant: HAN'S LASER TECHOLOGY INDUSTRY GROUP CO., LTD., Shenzhen (CN)

(72) Inventors: Jiaying LI, Shenzhen (CN); Chaoming ZHOU, Shenzhen (CN); Bo SUN, Shenzhen (CN); Yunfeng GAO, Shenzhen (CN)

(21) Appl. No.: 15/328,697

(22) PCT Filed: Sep. 19, 2014
(86) PCT No.: PCT/CN2014/086886

§ 371 Date: Jan. 24, 2017

(51) Int. Cl. F41H 13/00; G02B 27/09; G01C 3/08; F41G 3/06

(52) U.S. Cl. CPC F41H 13/0062; F41G 3/06; G02B 27/0955; G01C 3/08

(57) ABSTRACT

A laser composite system, comprising a plurality of lasers (10) and a laser range finder (13), the lasers (10) being kilowatt lasers, and the laser range finder (13) being used for determining the distance to a target object, and on the basis of said ranging results, controlling the focus of the plurality of lasers (10). High power such as that of a megawatt laser can be achieved by combining the plurality of kilowatt lasers (10), and, by using the laser range finder (13), the lasers (10) can automatically focus on a distant target object, thus resolving the problem of the inconvenience of aspects of high power lasers such as manufacturing and loading platforms, and the smaller scale is easy to transport and suited for use as an automated, very strong laser cannon.

### FIELD OF THE INVENTION

The present disclosure relates to an optical field, and more particularly, relates to a laser field utilizing a laser and a long distance beam expander.

### BACKGROUND OF THE INVENTION

At present, laser is applied throughout various fields, in military weapons a long range high power laser is adopted, its macro-energy and high power are employed to destroy a distant target, the long range high power laser is known as a laser cannon. Researches on the laser cannon have lasted more than haft a century. At present, although some phased achievements are obtained, there are many problems which cannot be resolved. The major problem is that, because of a long distance transmission, an extreme high power laser is required, for example, a ten kilowatts laser to a hundreds of kilowatts laser are required. In such an extreme high power laser, many problems are encountered in the manufacture, for example, the raw material for manufacturing the laser, various platforms for the laser, and the power provided for the laser, all are problems which cannot not be resolved. Some high power lasers are difficult to move which are determined by their volume and weight. Therefore, the flexibility is lacked and its applications are limited.

### SUMMARY

Accordingly, it is necessary to provide a combined laser system to overcome above shortcomings, in order to enable the combined laser system to be suitable for long distance high power transportation, and have improvements on the aspects of manufacture and movement.

A combined laser system includes: a plurality of lasers; and one laser range finder; wherein the laser is a kilowatts laser, the laser range finder is configured to determine a distance to a target object, and control focuses of the plurality of lasers according to a ranging result.

According to one embodiment, an optical system of each laser includes one beam expander, the beam expander includes one primary lens and one auxiliary lens, a laser light emitted from the laser propagates through the auxiliary lens, and then propagates through the primary lens; and the laser range finder is electrically connected to the beam expander of the laser, enabling a focus adjustment of the beam expander to be linked to the ranging result of the laser range finder.

According to one embodiment, Φ_{incident} of the beam expander is 5 millimeters, and Φ_{emergent} of the beam expander is 50 millimeters, and B=10 times.

According to one embodiment, an optical system of the laser range finder adopts a beam expander which is the same as the beam expander adopted by the laser.

According to one embodiment, a number of the plural of lasers is 12.

According to one embodiment, the plurality of lasers are arranged on one plane, or are arranged on one curved surface.

According to one embodiment, the plurality of lasers are arranged along one circle.

In the present disclosure, high power laser such as a ten kilowatts laser can be achieved by combining a plurality of kilowatt lasers, and by using the laser range finder, the lasers can automatically focus on a distant target object, thus resolving the problem of inconveniences of high power laser in aspects such as manufacturing and loading platform, and the laser having a smaller scale is easy to transport and suited for use as a highly automated laser cannon.

### BRIEF DESCRIPTION OF THE DRAWINGS

FIG. 1 is a side view of partial devices of a combined laser system according to an embodiment;

FIG. 2 is a side view of a long distance range beam expander of a combined laser system according to an embodiment;

FIG. 3 is a graphic diagram showing modulation transfer function M.T.F characteristic of the beam expander of FIG. 2;

FIG. 4 is a graphic diagram showing point spread function of the beam expander of FIG. 2; and

FIG. 5 is a graphic diagram showing geometry aberration of the beam expander of FIG. 2.

### DETAILED DESCRIPTION OF THE EMBODIMENTS

Embodiments of the invention are described more fully hereinafter with reference to the accompanying drawings, in which preferred embodiments of the invention are shown. The various embodiments of the invention may, however, be embodied in many different forms and should not be construed as limited to the embodiments set forth herein. Rather, these embodiments are provided so that this disclosure will be thorough and complete, and will fully convey the scope of the invention to those skilled in the art.

It will be understood that when an element is referred to as being “fixed to” to another element, it can be directly fixed to the other element or intervening elements may be present. When an element is referred to as being “connected” or “coupled” to another element, it can be directly connected or coupled to the other element or intervening elements may be present.

Unless otherwise defined, all terms used herein have the same meaning as commonly understood by one of ordinary skill in the art to which this invention belongs. Terms in the description of the invention are for the purpose of describing specific embodiments, and are not intend to limit the invention. As used herein, the term “and/or” includes any and all combinations of one or more of the associated listed items.

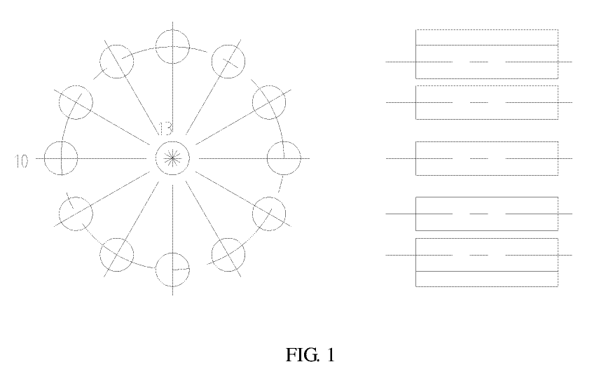

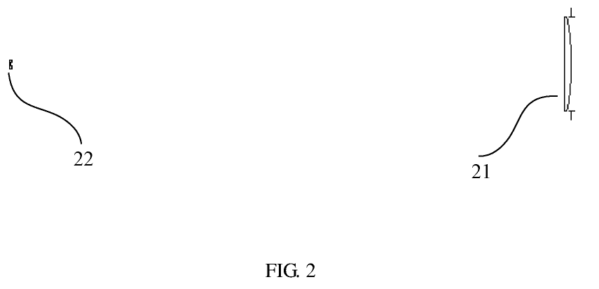

FIG. 1 and FIG. 2 show side views of a combined laser system provided by one embodiment of the present disclosure. The combined laser system includes a plurality of lasers 10 and one laser range finder 13.

The laser 10 is a kilowatts laser. The kilowatts laser 10 is selected to cause a manufacture of the laser and a platform framework to be easily implemented, and the laser has a small volume and is easy for transportation. The laser 10 can be a laser such as a chemical laser, and a solid-state laser. In one specific embodiment, the number of the lasers 10 is 12, the plurality of lasers can be arranged on one plane, and can also arranged on one curved surface, or the plurality of lasers are arranged in a different three-dimensional shape. In one specific embodiment, the 12 lasers 10 are arranged along one circle. The laser 10 is configured to emit a laser to strike a target object.

The laser range finder 13 is one high-speed laser range finder. The laser range finder 13 is configured to perform a ranging to the target object, and control a focus distance of the laser 10, so as to enable the laser 10 to perform a strike to the target object.

The laser range finder 13 can have a structure the same as that of the laser 10, i.e. the laser range finder 13 is also a laser. However, in the system, the laser range finder 13 provides a function to range the target object, not to strike the target object.

The functions of the laser 10 and the laser range finder 13 cannot be realized without an accurate optical system. As shown in FIG. 2, in one embodiment, the optical system of the laser 10 includes one beam expander. The beam expander is a long distance beam expander which can expand a laser light emitted by the laser 10. In the present disclosure, one beam expander corresponds to one laser 10, and the laser range finder 13 is electrically connected to the beam expander of the laser 10, so as to link a focus adjustment of the beam expander to a ranging result of the laser range finder 13, thereby realizing an integration of the laser range finder 13, the laser 10, and the beam expander.

The beam expander includes one primary lens 21 and one auxiliary lens 22. The laser light emitted from the laser 10 propagates through the auxiliary lens 22, and then propagates through the primary lens 21. A divergence angle of the beam expander can be adjusted to suit a focusing at different distances. In one embodiment, an incident diameter Φ_{incident} of the beam expander is 5 millimeters, and an emergent diameter Φ_{emergent} of the beam expander is 50 millimeters, B=10 times.

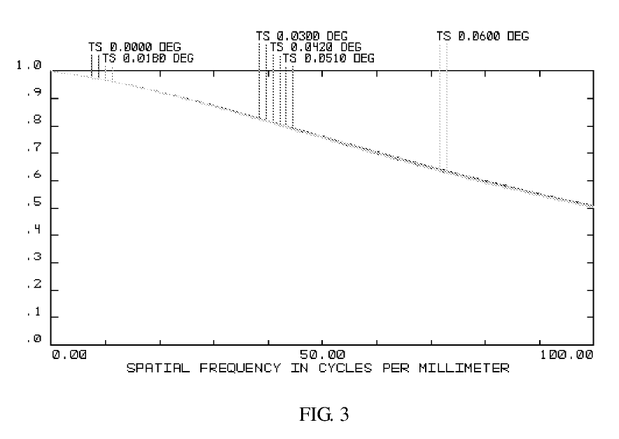

As shown in FIG. 3, it is a graphic diagram showing modulation transfer function M.T.F characteristic of the beam expander, when the resolution reaches 100 line pairs, the M.T.F is still more than 0.7.

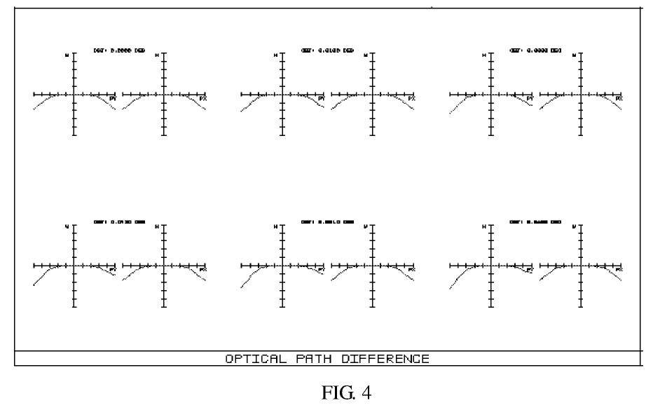

As shown in FIG. 4, it is a graphic diagram showing point spread function of the beam expander, the result is very good.

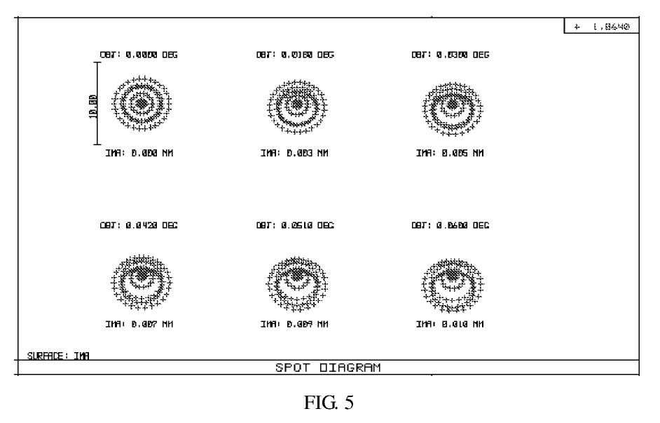

As shown in FIG. 5, it is a graphic diagram showing geometry aberration of the beam expander, a dispersion circle is relative small, a full field Δd≦1 μm.

In one embodiment, aforementioned beam expander can also be applied to an optical system of the laser range finder 13.

When the combined laser system of the present disclosure is used, the laser range finder 13 is employed to perform a ranging to the target object, and the laser 10 is controlled to focus on the target object and emit a laser to the target object, such that shootings to the target object can be realized. The laser range finder 13 can perform a ranging to the target objects at different distances, and performs a focusing to the laser 10 automatically, thereby realizing shootings to the target objects at different distances.

In the present disclosure, high power laser such as a ten kilowatts laser can be achieved by combining a plurality of kilowatt lasers 10, and by using the laser range finder 13, the lasers 10 can automatically focus on a distant target object, thus resolving the problem of inconveniences of high power lasers in aspects such as manufacturing and loading platform, and the laser having a smaller scale is easy to transport and suited for use as a highly automated laser cannon.

The above are several embodiments of the present invention described in detail, and should not be deemed as limitations to the scope of the present invention. It should be noted that variations and improvements will become apparent to those skilled in the art to which the present invention pertains without departing from its spirit and scope. Therefore, the scope of the present invention is defined by the appended claims.

What is claimed is:

1. A combined laser system, comprising:
a plurality of lasers; and
one laser range finder;
wherein the laser is a kilowatts laser, the laser range finder is configured to determine a distance to a target object, and control focuses of the plurality of lasers according to a ranging result.

2. The combined laser system according to claim 1, wherein an optical system of each laser comprises one beam expander, the beam expander comprises one primary lens and one auxiliary lens, a laser light emitted from the laser propagates through the auxiliary lens, and then propagates through the primary lens; and the laser range finder is electrically connected to the beam expander of the laser, enabling a focus adjustment of the beam expander to be linked to the ranging result of the laser range finder.

3. The combined laser system according to claim 2, wherein an incident diameter of the beam expander is 5 millimeters, and an emergent diameter of the beam expander is 50 millimeters, and B=10 times.

4. The combined laser system according to claim 3, wherein an optical system of the laser range finder adopts a beam expander which is the same as the beam expander adopted by the laser.

5. The combined laser system according to claim 1, wherein a number of the plurality of lasers is 12.

6. The combined laser system according to claim 1, wherein the plurality of lasers are arranged on one plane, or are arranged on one curved surface.

7. The combined laser system according to claim 1, wherein the plurality of lasers are arranged along one circle.
